(19) United States
(12) Patent Application Publication
(10) Pub. No.: US 2005/0121592 A1
(43) Pub. Date: Jun. 9, 2005

(54) Vibration isolated table for a charged particle beam apparatus provided with a shock protection element and shock protection element

(76) Inventors: Johannes A.P.G. Van Der Ven, Eindhoven (NL); Albertus Gerhardus Dirks, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/486,469

(22) Filed: Feb. 9, 2004

(30) Foreign Application Priority Data
Dec. 19, 2002 (EP) 02080823.8

(51) Int. Cl. F16M 1/00

(52) U.S. Cl. 248/637

(57) ABSTRACT

A vibration isolated table for a charged particle beam apparatus is provided with a shock protection element (5).

The vibration isolated table (1) has a frame (2) and a load plate (3) being connected to the frame through vibration dampers (4). The shock protection element is connected to the frame (2) and extends over the load plate (3). There is free space (6) between a top plate (7) and the load plate (3), so that shock impacts are transferred to the frame and no longer to the load plate on which the charged particle beam is mounted.

The invention relates to a vibration isolated table for a charged particle beam apparatus, the table having a frame and a load plate being connected to the frame through vibration dampen.

The invention firmer relates to a shock protection element.

In a charged particle beam system, vibration propagating from a floor is commonly intercepted or suppressed by mounting the apparatus on a vibration isolated table. There are active vibration isolated tables that actively vary position and height of the table in order to suppress vibration.

JP 96162982-A discloses a vibration isolated table of the kind mentioned in the opening paragraph A charged particle beam apparatus in the form of a scanning electron microscope is positioned on the load plate. The scanning electron microscope comprises a specimen chamber and a column. Inside the chamber a sample stage is mounted, and a sample is held on the sample stage through a sample holder. The specimen chamber is vacuum pumped by a pumping system. The pumping system is suspended from the specimen chamber.

The scanning electron microscope is prevented from generating a relative displacement between an electron beam and the sample due to the vibration of the ground and the like. To this end the vibration isolated table is provided with a vibration protection element. The vibration detection element has a vibration detector and a control circuit for deflecting the electron beam with a deflection coil in accordance with a signal from the vibration detector.

It is a problem that the charged particle beam apparatus on the vibration isolated table and the pumping system suspended from the specimen chamber are not protected against shocks. If a person leans on, or even worse, try to sit on or, by accident pushes against the vibration isolated table the charged particle beam apparatus, the sample in it or the pumping system is damaged.

It is an object of the invention of the kind mentioned in the opening section, to prevent the charged particle beam apparatus and the pumping system from impact shocks.

The object according to the invention is achieved in that a shock protection element is connected to the frame and extends over the load plate.

When a strong force is exerted on the shock protection element, the force is absorbed by the protection element and transferred to the frame. The impact shock is not transferred to the load table. The specimen chamber on the load plate and the pumping system suspended from the chamber are not disturbed. Impact shocks on the vibration isolated table due to accidental pushing, leaning or even sitting of a person on the protection element do not longer incline the load plane. The turbo molecular pump, being part of the pumping system, no longer suffers from damage due to unbalance of the inclined load plate. The turbo molecular pump remains in a horizontal position, even with a very strong impact shock.

Preferably there is free space between the load plate and the shock protection element. As long as there is no physical contact between the shock protection element and the load plate, the charged particle beam apparatus and the pumping system can be considered as decoupled systems for vibrations and shocks.

It is advantageous when the shock protection element has an opening in the top plate. The charged beam apparatus can be positioned through the opening of the plate and rests on the load plate. The turbo molecular pump of the pumping system suspended from the chamber extends through an opening of the load plate. Preferably the specimen chamber is aligned with the center of the opening in the load plate. The opening of the load plate can be aligned with the opening of the plate of the shock protection element.

It is advantageous when the opening in the top plate of the shock protection element is larger than the opening in the load plate. In order to load the specimen chamber with a new sample, a door of the specimen chamber has to be opened. If the top plate extends over the load plate, even below the open door, the spacing between the lowest part of the door and the top plate of the protection element should be large enough.

In order to be sure that the door of the specimen chamber can be opened, the top plate of the shock protection element is positioned substantially parallel to the load plate.

In another embodiment the top plate is only a strip, extending only over a certain part of the load plate. In this specific embodiment, at the area where the door of the specimen chamber has to be opened, there is no top plate present.

For easiness of manufacturing, the shock protection element comprises a folded plate. The plate can be a metal like steel or aluminum. The material can be a synthetic material, for instance manufactured by moulding, or the material can be a wood. As long as the material has a sufficient stiffness it can be used.

These and other features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

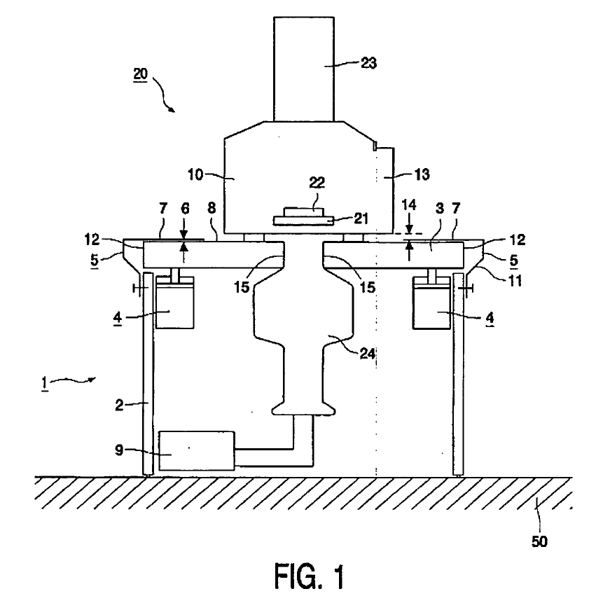

FIG. 1 is a schematic drawing of a vibration isolated table for a charged particle beam apparatus provided with the shock protection element according to the invention.

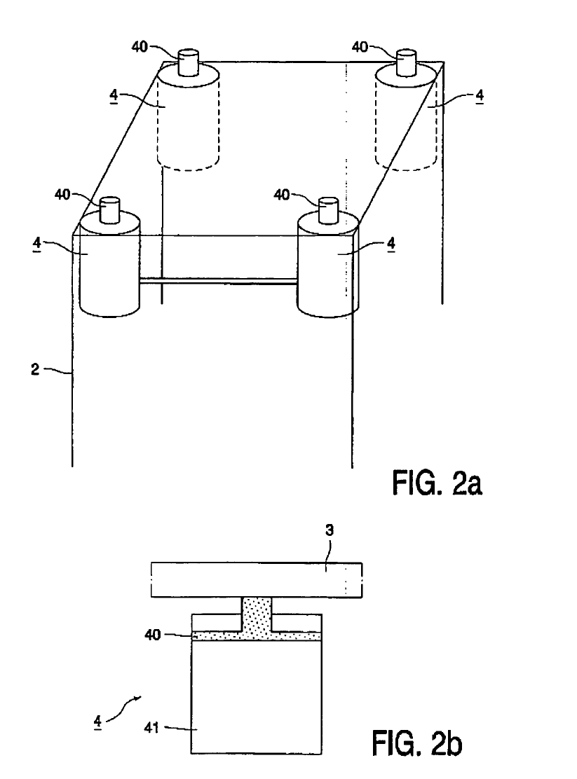

FIG. 2a is a schematic drawing of an embodiment of the vibration dampers.

FIG. 2b is a schematic drawing of the load plate resting on one of the vibration dampers.

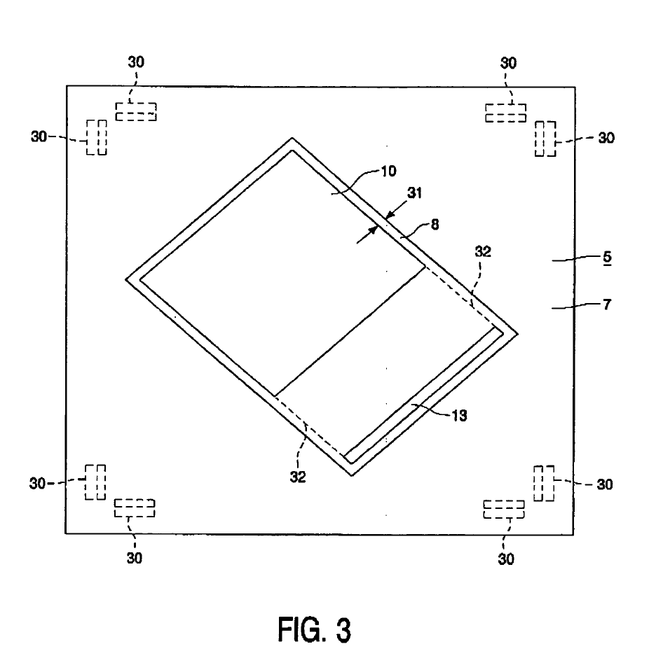

FIG. 3 is a top view of a first embodiment of the shock protection element.

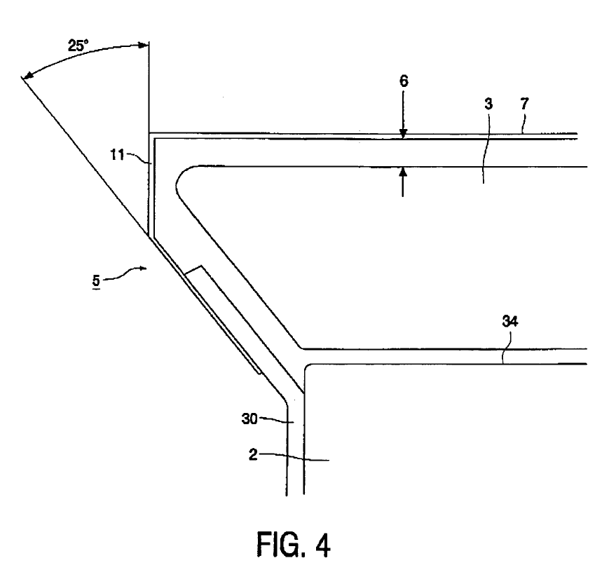

FIG. 4 is part of a cross sectional view corresponding to the first embodiment shown in FIG. 3.

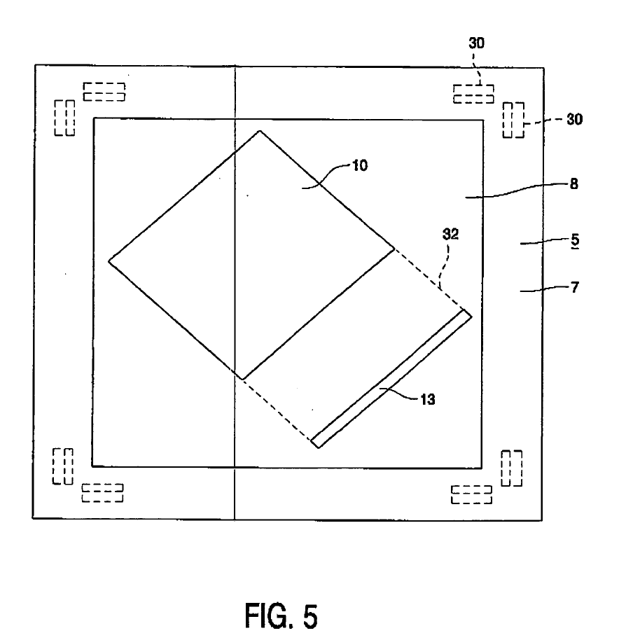

FIG. 5 is a top view of a second embodiment of the shock protection element.

The vibration isolated table 1 in FIG. 1 has a frame 2 and a load plate 3 being connected to the frame through vibration dampers 4. A charged particle beam apparatus 20 in the form of a focussed ion beam (FIB) is present on the load plate. In this example the charged particle beam apparatus is a FIB, but it can be any apparatus like an secondary emission microscope (SEM), a transmission electron microscope (TEM), an electron beam pattern generator (EBPG), or e.g. an helium ion beam system for lithography purposes.

The focussed ion beam apparatus 20 has a specimen chamber 10 with a stage 21 for mounting a sample 22. A column 23 comprises a Ga⁺ ion source for generating an ion beam. The specimen chamber is vacuum pumped by a pumping system 9. The pumping system comprises a roughing pump for obtaining sufficient pre-vacuum conditions after which a turbo molecular pump 24 is switched on. The turbo molecular pump 24 is suspended from the specimen chamber. An ion getter pump is employed for evacuation the column. If the vacuum of the specimen chamber 10 is in the order of 10⁻⁷ atmosphere, the shutter between the column and the specimen chamber is opened. At that time all pumps are evacuating tie specimen chamber and the column in order to obtain clean surfaces of the sample during the ion milling process.

The charged particle beam apparatus is positioned on the load plate 3 of the vibration isolated table. Four gas-pressure cylinders 4 function as vibration dampers as shown in see FIG. 2a. The cylinders 4 are located in each corner below the load plate 3 and are fixed on the frame 2. Each cylinder comprises pressurized gas and a piston. The load plate 3 rests on the pistons 40. FIG. 2b shows part of the load plate 3 resting on a piston 40. Usually one of the cylinders has a fixed gas pressure. Two other cylinders are coupled by the gas and are pressurized simultaneously. The gas of the fourth cylinder can be tuned independently in order to obtain a practical horizontal position of the load plate. Since the vibration dampers are partly interconnected with pressured gas 41 (e.g. air or nitrogen), they are able to reduce vibrations originating from the floor 50. However, the air-pressured cylinders can only react relatively slowly and are not suitable to absorb a shock impact. In order to absorb shocks, a shock protection element 5 according to the preset invention is connected to the frame 2.

FIG. 3 shows a top view of a first advantageous embodiment of the shock protection element. In this embodiment the shock protection element 5 is a folded metal plate. The folded plate is rigidly attached on the sides of the frame using folded clamp 30 and is designed such that it forms an envelope around the “vulnerable” edges of the load plate 3. The top plate of the shock protection element extends over the load plate of the vibration isolated table. In the plate 7 there is an opening 8, in order to be able to mount the shock protection element 5 around the specimen chamber 10. There is a spacing 31 between the specimen chamber 10 and the top plate 7 of the protection element, in order to circumvent vibrations and shocks exerted on the top plate to be transferred to the specimen chamber. In a preferred embodiment the opening 8 in the top plate is sufficient to open the door 13 of the specimen chamber within the opening 8. In the top view of FIG. 3 this situation is shown. The dashed lines 32 indicate the translation of the door to the open position. The specimen chamber is usually mounted 45 degrees rotated with respect to the frame, so that the door has the longest possible distance to the edge of the load plate. In the corners small clamps 30 are present underneath the top plate 7 which are connectable to the frame.

In the corresponding cross-sectional view of FIG. 4 the metal plate 11 is folded so that there is a 5 mm spacing 6 between the load plate 3 and the top plate 7 of the shock protection element. The folded plate 11 is manufactured from a steel plate having a thickness of e.g. 2 mm. Small steel strips 30 are welded to the folded plate 11 for connection to the frame 2. The small steel strips 30 have a width of e.g. 50 mm and are mounted to the frame 2 of the vibration isolated table. Usually the small strips in the corners are mounted to the legs of the table with a screw or any other connection mean well known to the person skilled in the art. In this example the size of the folded plate in the height direction is 85 mm, the angle between the lower part and the vertical part of the folded plate is 25 degrees.

If a person puts an object on the top plate 7 of the shock protection element, pushes against or even worse is leaning on or sitting on the top plate, the force is exerted to the frame 2 of the vibration isolated table. In case of inattentive or accidental physical contact with the protective top plate of the shock protection element possible impact On the charged particle beam apparatus and the vacuum system is thus minimized.

The top plate can extend below the door 13 of the specimen chamber 10. In that case the distance between the top plate 7 and the upper part 34 of the frame is limited

The height between the lowest part of the door 13 and the top plate 7 of the shock protection element is critical. When the door is opened for inserting a sample, or for pair, the door should not run against the top plate. In the commercially available FEI FIB 200 system, the load table has its lowest position and rests on the legs of the frame in case the specimen chamber is vented. The spacing 6 between the top plate of the protection element and the load plate then has a maximum of roughly 13 mm.

It is important that there is always free space 6 between the load plate 3 and the top plate 7 of the shock protection element. When the specimen chamber is vented, the spacing 6 is maximal. The load plate 3 then rests on the frame 2.

When pressured gas is pumped into the cylinders, the pistons rise and the load plate resting on the pistons rises as well. The spacing 6 between the top plate 7 and the load plate 3 reduces. During the inlet of gas in the cylinders, the load plate is not always horizontal. The inlet of pressured gas in the cylinders usually does not occur in all cylinders at the same time. The load table can incline, which results in a local reduction of the spacing between the load plate 3 and the top plate 7. Since the pistons have the highest position when the gas is under the highest adjustable pressure, the distance between the top plate and the load plate should therefore exceed at least the maximum distance the pistons are allowed to move. In the FEI FIB 200 system the distance the pistons can move from atmospheric pressure to the highest adjustable pressure being roughly 6 mm. In practice, under operation (that means when the specimen chamber is vacuum evacuated) the distance between the load plate and the upper part of the frame 34 is typical 3- 5 mm.

FIG. 5 shows a top view of an advantageous embodiment of the shock protection element. The top plate 7 is in this embodiment a metal strip. In practice inattentive people may lean or sit on the edge of the table. A strip extending only over a small area of the load plate and having a typical width of e.g. 50 mm is therefore usually sufficient for protecting the charge particle beam apparatus and the turbo molecular pump against impact shocks. The shock protection element can be provided such that it extends over only one, two, three or all edges of the load table.

The material of the shock protection element is not limited to a metal like steel or aluminum. The shock protection element can be produced from a synthetic material such as hard PVC, e.g. by a moulding technology.

The shape of the shock protection element can be part of a rectangle, an ellipse or have an arbitrary shape, as long as it can form an envelope over the edge of the load plate of the table.

1. Vibration isolated table for a charged particle beam apparatus, the table having a frame and a load plate being connected to the frame through vibration dampers, characterized in that a shock protection element is connected to the frame and extends over the load plate.

2. Vibration isolated table as recited in claim 1, characterized in that there is a space between the shock protection element and the load plate.

3. Vibration isolated table as recited in claim 1, characterized in that the shock protection element comprises a plate having an opening.

4. Vibration isolated table as recited in claim 1, characterized in that the plate is positioned substantially perpendicular to the frame.

5. Vibration isolated table as recited in claim 3, characterized in that the opening in the plate is larger than an opening in the load plate.

6. Vibration isolated table as recited in claim 1, characterized in that the charged beam apparatus is positioned through the opening of the plate and rests on the load plate.

7. Vibration isolated table as recited in claim 3, in which the charged particle beam apparatus further comprises a pumping system suspended from a specimen chamber of the charged particle beam apparatus, characterized in that the charged beam apparatus and the pumping system are aligned substantially perpendicular to the plate.

8. Vibration isolated table as recited in claim 3, characterized in that the plate extends substantially parallel to the load plate.

9. Vibration isolated table as recited in claim 1, characterized in that the shock protection element comprises a folded plate.

10. Vibration isolated table as recited in claim 1, characterized in that the plate follows an edge of the load plate.

11. Vibration isolated table as recited in claim 7, in which the sample chamber comprises a door, characterized in that there is a spacing between the door and the plate.

12. Vibration isolated table as recited in claim 11, characterized in that the spacing between the plate and the load plate is less than 10 mm.

13. Vibration isolated table as recited in claim 1, characterized in that the plate of the shock protection element is a strip.

14. Shock protection element for a vibration isolated table comprising a folded plate.

15. Shock protection element as claimed in claim 14, characterized in that the material of the folded plate is a metal.
